(19) United States
(12) Patent Application Publication
(10) Pub. No.: US 2018/0042231 A1
(43) Pub. Date: Feb. 15, 2018

(54) Systems and Methods for the Continuous On-Site Production of Peroxycarboxcylic Acid Solutions

(71) Applicant: Eltron Water Systems, LLC, Boulder, CO (US)

(72) Inventors: Andrew S. Del Negro, Broomfield, CO (US); Paul Grimmer, Longmont, CO (US); David H Anderson, Boulder, CO (US); Daniel J Riffell, Berthoud, CO (US)

(73) Assignee: Eltron Water Systems, LLC, Boulder, CO (US)

(21) Appl. No.: 15/676,751

(22) Filed: Aug. 14, 2017

Related U.S. Application Data
(60) Provisional application No. 62/374,180, filed on Aug. 12, 2016.

(51) Int. Cl. A01N 37/16; B01J 19/00; B01J 19/24; B01J 14/00

(52) U.S. Cl. CPC A01N 37/16; B01J 14/00; B01J 19/0006; B01J 19/2415; B01J 2219/00164; B01J 2219/00033; B01J 2219/00177; B01J 2219/00186

(57) ABSTRACT

Methods and systems for on-site production of peroxycarboxcylic acid compositions, and in particular, nonequilibrium compositions of peracetic acid (PAA) enable the economical and safe production of PAA on-demand at the point of use. The methods and systems control flow rates and proportions of feedstocks/reactants, perform the required sequence of reaction steps to produce high yield peroxycarboxcylic acid solutions in a continuous manner, and provide optimal reaction time and reactant mixing for continuous and safe on-site production.

### CROSS-REFERENCE TO RELATED APPLICATIONS

This application is a claims the benefit of U.S. Provisional Application No. 62/374,180, filed Aug. 12, 2016; the entire disclosure of which is incorporated herein by reference.

The present invention relates to methods and systems for the continuous production of nonequilibrium solutions containing biocidal concentrations of certain acids. More specifically, the present invention relates to methods and systems for producing nonequilibrium solutions containing biocidal concentrations of peroxycarboxcylic acids, including peracetic acid, on-demand and at the point-of-use.

### BACKGROUND OF THE INVENTION

Peracetic acid (PAA) is a strong disinfectant with a wide spectrum of antimicrobial activity. PAA is conventionally prepared by reaction of concentrated acetic acid (AA) and concentrated hydrogen peroxide (HP). Strong, homogeneous acidic catalysts (e.g. 1-20% sulfuric acid) are usually used to catalyze the reaction toward equilibrium. The reactants are supplied to a reactor and are mixed and converted to product mixture within the reactor. These mixtures are prepared in large quantities at a plant and after reaction, placed in storage or shipping containers and allowed to “cure” for several days during which time the mixture approaches and reaches steady state equilibrium. Because these mixtures are stored and shipped after the PAA formation reaction has reached equilibrium, they are referred to as “equilibrium mixtures”.

The equilibrium PAA mixtures are typically prepared in concentrations between 5-35% (wt.) PAA containing excess HP and AA with water making up the balance, i.e., high concentrations of HP and/or AA relative to PAA concentration. Stabilizers must be added to the equilibrium PAA to prevent decomposition during storage and transport to end-users. Major uses of equilibrium PAA include disinfection, bleaching and chemical synthesis. Current practice for such applications is distribution of bulk equilibrium PAA solutions from large manufacturing plants to locations of end-use, often involving multiple distributors and transport events. These solutions must be shipped in compliance with regulations for hazardous materials (corrosive, oxidizer) and are explosive. After delivery to the end-user, the equilibrium PAA is typically stored in vented drums until use. PAA concentrations up to 15% are typically used for water treatment, for sanitizing, disinfecting, and sterilizing in the food and beverage industry, in laundries and for medical applications. Higher PAA concentrations up to 40% are exclusively used for oxidation reactions.

In aqueous solution peracetic acid is in a chemical equilibrium with acetic acid, hydrogen peroxide and water. This equilibrium is represented in the following Equation (1):

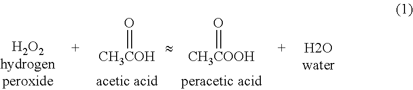

Accordingly, a higher concentration of reactants is required to produce a higher concentration of peracetic acid. Conversely, a higher concentration of water will drive the reaction backwards, which means dilute solutions have very low PAA equilibrium concentrations and mostly contain water and unused starting materials.

The molar concentration ratio of products versus reactants gives an equilibrium ratio often referred to as the equilibrium constant. Equilibrium constants for solutions of peroxycarboxylic acids can be determined by common methods. The equilibrium constant of a peroxycarboxylic acid can be determined by the following Equation (2A):

$$\frac{[ RCO— O \text{—} OH ] [ {H}_{2} O ]}{[ RCO \text{—} OH ] \times [ {H}_{2} {O}_{2} ]} = equilibrium constant \qquad ( 2 A )$$

The equilibrium constant of PAA can be determined by the following Equation (2B):

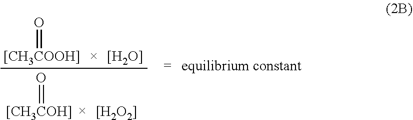

For equilibrium peracetic acid solutions this equilibrium constant typically ranges between 1.8 and 2.5 (D. Swern, ed., Organic Peroxides, Wiley-Interscience, New York, 1970-72).

An example of typical equilibrium compositions commercially produced and distributed in bulk is 5-35% by weight peracetic acid, up to 30% hydrogen peroxide, up to 40% acetic acid and the balance being water. The weight ratio of hydrogen peroxide to peracetic acid to acetic acid in the merchant products ranges between 4.6:1:1.3 (5-6% PAA equilibrium product) and 1:5.4:6.2 (35% PM equilibrium product). Using only the [H₂O₂]:[PAA] ratio is an oversimplified definition for distinguishing equilibrium from nonequilibrium peracetic acid solutions in that it does not represent the acetic acid constituent involved with the equilibrium constant.

A large investment cost is associated with the production of equilibrium PAA mixtures in a centralized plant, due to the high materials and equipment cost. The extended time needed for reaction to reach equilibrium is a further limitation. Practical production of the equilibrium mixtures requires the use of a catalyst which then needs to be separated from the product by costly purification steps. To minimize the impact of shipping costs, the equilibrium mixtures are produced at relatively high concentrations and then diluted at the point-of-use. However, these mixtures are hazardous and explosive and require costly shipping and handling procedures. The shipping volume is limited to less than 300 gallons per container due to the hazardous nature of the equilibrium mixtures, creating challenging and costly logistics for large volume end-users. The abovementioned issues result in a PAA product mixture that is more costly to the end-user, as well as more dangerous than embodiments of the present invention.

It is possible to produce PAA on-site. Large quantities of equilibrium PAA can be produced by blending concentrated hydrogen peroxide and acetic acid in water. Sulfuric acid may also be added as a catalyst to accelerate the equilibration. The blended solution is allowed to ‘cure’ for at least 6-10 days while reaching chemical equilibrium prior to use. The cure time increases with decreasing concentration of either starting material and is several weeks or longer at very low point-of-use concentrations. Most applications using peracetic acid (with the exception of pulp bleaching) are regulated to use less than 170 mg/L concentrations for hard surface cleaning and less than 80 mg/L for contact with produce and often less than 10 mg/L for water treatment.

As an example of the drawback to producing low concentration equilibrium solutions, a 200 mg/L concentration of peracetic acid in an equilibrium solution would contain 4000 mg/L hydrogen peroxide and 35,000 mg/L acetic acid that is unused starting material (equilibrium constant=2.05). In contrast, nonequilibrium peracetic acid solutions can contain 200 mg/L peracetic acid, 200 mg/L hydrogen peroxide and 160 mg/L acetic acid (equilibrium constant=9315). Therefore to directly produce low concentrations of peracetic acid rapidly and economically on-site, a nonequilibrium product is required.

“Nonequilibrium” refers to chemical mixtures that do not provide a determined equilibrium constant value, such as those determined by Equation (2A) for peroxycarboxylic acids in general, or by Equation (2B) for peracetic acid solutions. Accordingly, a nonequilibrium PAA solution is optionally described as having an equilibrium constant typically as calculated by Equation (2) that is not between 1.8 and 2.5.

Conventional nonequilibrium peracetic acid solutions are commercially produced in bulk by first producing equilibrium PAA, followed by distillation of such equilibrium PAA. The nonequilibrium distillate must then be stored near its freezing point to minimize decomposition and re-equilibration during storage. This method of producing nonequilibrium peracetic acid is not practical for on-site end-users due to the complexity of such a production process, the operating skill required, the use of concentrated hazardous materials, and the explosion hazard created by distillation of concentrated peroxides.

To address some of these challenges, there have been various attempts to make solutions of PAA on-site, at the point-of-use. Equilibrium mixtures can be produced on-site by continuous production of a mixture of the individual components of equilibrium PAA (U.S. Pat. No. 6,719,921). The slow rate of reaction to equilibrium requires the use of a strong acid catalyst and therefore the catalyst is present in the product mixture. The reaction of individual components to form the equilibrium occurs in a reaction vessel with enough volume to give the reaction mixture enough residence time to reach equilibrium. This may lead to increased and impractical startup times in the event of planned or unplanned system shutdowns. The nature of the equilibrium mixture means that there is inherently some proportional quantity of reactants (HP and AA) left in the product mixture. This equilibrium reaction utilizes the feedstocks (HP and AA) in a less efficient manner than the irreversible and rapid reaction to produce nonequilibrium mixtures in embodiments of the present invention. The rapid reaction in embodiments of the present invention minimizes the system startup time making it more suitable for on-demand production of PAA at the point-of-use.

Reactive precursor mixtures can be reacted with a stream of alkali metal hydroxide to produce nonequilibrium PAA mixtures at the point-of-use. U.S. Pat. App. Pub. No. 2012/0245228 describes a premixed stream of acetyl donor and hydrogen peroxide reacted with a stream of sodium or potassium hydroxide. The alkaline environment allows for the perhydrolysis reaction of peroxide, producing nonequilibrium PAA mixtures. This process is difficult to control due to the instability of the reactive precursor mixture, as well as the heterogeneity of the precursor mixture, and is less efficient (in terms of % yield) compared to embodiments of the present invention. The lower yield results in a PAA composition with increased acetic acid compared to embodiments of the present invention. The costs associated with preparing the precursor mixture as well as the lower PAA yield for the reaction result in a more costly PAA mixture than embodiments of the present invention.

U.S. Pat. No. 5,505,740 describes a method for in-situ formation of peroxyacid using peracid precursor, a source of hydrogen peroxide and a source for delayed release of acid for a bleaching product (wash solution) and a method of removing soil from fabrics. In the method of Kong et al. the aqueous wash solution is initially raised to a relatively high pH level (e.g., 9.5) to enhance production of the peroxyacid in the aqueous solution, followed by lowering the pH of the aqueous solution by, for example, the delayed release of acid, to enhance bleach performance. The source of the delayed release of acid may be an acid of delayed solubility, an acid coated with a low solubility agent or an acid generating species, or an acid independent of the bleaching product employed.

British Pat. Pub. No. GB 1,456,592 relates to a bleaching composition having both encapsulated bleaching granules and agglomerated pH-adjustment granules acid. The bleaching granules comprise an organic peroxy acid compound stabilized by salt(s) of strong acids and water of hydration, encapsulated in a fatty alcohol coating. The pH-adjustment granules comprise a water-soluble alkaline buffer yielding pH 7-9 agglomerated with a suitable adhesive material to yield the desired solubility delay. Preferred peroxy acid compounds are diperisophthalic acid, diperazelaic acid, diperadipic acid, monoperoxyisophthalic acid, monosodium salt of diperoxyterephthalic acid, 4-chlorodiperoxyphthalic acid, p-nitroperoxy benzoic acid, and m-ehloroperoxy benzoic acid.

U.S. Pat. No. 6,569,286 and published PCT Pub. No. WO 0019006 (App. No. WO1999GB03178) relate to a process for bleaching of wood and non-wood pulp. In this process an agglomerate containing, among others, a bleach activator (e.g., tetraacetylethylenediamine, TAED) and a peroxide soluble binder (e.g., polyvinyl alcohol) is added to a dilute solution of hydrogen peroxide. The components are allowed to react and the pH of the resulting mixture is chemically adjusted to a suitable alkaline pH and the pulp is contacted with the resulting solution.

Peracids can be produced in electrochemical cells or reactors by establishing a potential difference across electrodes immersed in electrically-conducting fluid and introducing appropriate reactant materials. For example, U.S. Pat. No. 6,387,238 relates to a method for preparing an antimicrobial solution containing peracetic acid in which hydrogen peroxide or peroxide ions are formed electrolytically and the hydrogen peroxide or peroxide ions are then reacted with an acetyl donor to form peracetic acid.

U.S. Pat. No. 6,949,178 discloses a process and apparatus for the preparation of peroxyacetic acid at the cathode of an electrolytic cell having an ionically conducting membrane in intimate contact between an anode and a gas diffusion cathode. The method comprises supplying an aqueous organic acid solution to the anode, supplying a source of oxygen to the cathode, and generating peroxyacid at the cathode.

European Patent EP1469102 discloses the process and apparatus for electrolytically producing peracetic acid from acetic acid or acetate using an electrolytic cell incorporating a gas diffusion electrode in the presence of a solid acid catalyst.

JP-T-2003-506120 discloses the electrolytic synthesis of peroxyacetic acid. In this method, oxygen gas is electrolyzed to obtain peroxide species which are then reacted with acetylsalicylic acid to obtain the peroxyacetic acid.

PCT Pub. No. PCT/US2011/000539 filed Mar. 23, 2011, discloses hydrogen peroxide-acetyl precursor solutions for use in generating non-equilibrium solutions of PAA. The precursor solutions comprise a solution of aqueous hydrogen peroxide, a liquid acetyl precursor that is soluble in aqueous hydrogen peroxide, a trace amount of peracetic acid and water. The preferred liquid acetyl precursor disclosed in the '539 publication is identified as triacetin, which exhibits a high solubility in hydrogen peroxide. However, triacetin is not very soluble in water, and the reaction times attained using the processes therein disclosed fall in a range of approximately 30 seconds to approximately two minutes—times which are too slow for practical point of use applications.

Other disadvantages of known methods are, among others, (1) the long reaction or cure times required to produce equilibrium concentrations of peracetic acid solutions; (2) costs of shipping, handling, and storage, (3) limited shelf life of concentrated acids, bases, and peroxides, which are all corrosives and hazardous materials; (4) cost of shipping large quantities of water containing merchant hydrogen peroxide; (5) the presence of stabilizers or contaminants originating from merchant hydrogen peroxide; and (6) relatively low production rates or excessive equipment size and cost. In addition, the practice of combining bulk chemical constituents obtained from merchant suppliers to produce nonequilibrium peroxycarboxylic acid solutions, including peracetic acid, does not produce the compositions provided herein. Processes and related devices provided herein eliminate these disadvantages and other disadvantages associated with shipping, storing and handling concentrated merchant peracetic acid.

A process that mixes reactants with fewer storage or shipping requirements than the product solution, rapidly and safely, to provide the benefits of a nonequilibrium solution of a peroxycarboxylic acid and the benefits of on-site mixing with a high yield would be advantageous. The process to efficiently produce continuous nonequilibrium PAA requires manipulating and reacting the feedstocks in a particular sequence and maintaining specific ratios to prevent the accidental formation of unsafe mixtures and to maintain proportional flow of feedstock reactants to ensure optimal reaction conversion, and thereby, economic PAA production.

Consequently, a need exists for an efficient and virtually instantaneous process of preparing peroxycarboxylic acids, including peracetic acid, on-site, on-demand, rapidly and cost-effectively using liquid acetyl precursors, such as triacetin.

### SUMMARY OF EMBODIMENTS OF THE INVENTION

The stated problems and other needs in the art as are apparent from the further description can be achieved by the process according to the methods and systems of embodiments of the present invention. Production at the point-of-use negates many of the costs and safety liabilities associated with transporting bulk equilibrium peroxycarboxcylic acid mixtures. The methods and systems are rapid, low-cost and simple, allowing the virtually instantaneous nonequilibrium peroxycarboxcylic process to occur at the point-of-use by the end-users of the nonequilibrium peroxycarboxcylic mixtures. The system controls flow rates, proportions of reactants, mixing methods and the required sequence of reaction steps to produce high yield peroxycarboxcylic acid solutions in a continuous manner, and provides optimal reaction time, reactant stream proportions, mixed stream pH, and optimum reactant mixing for continuous and safe on-site production.

Embodiments of the invention provide methods of production of nonequilibrium peroxycarboxylic acids and solutions containing nonequilibrium peroxycarboxylic acid for various applications. The invention also provides compositions comprising nonequilibrium peroxycarboxylic acids made by the methods herein. The novel methods and compositions herein are particularly useful for preparation of nonequilibrium peracetic acid (PAA) solutions. PAA is a representative peroxycarboxylic acid. Methods and compositions herein which are exemplified with PAA can be practiced in general with any one or more peroxycarboxylic acids.

The invention provides a method of producing nonequilibrium peracetic acid that facilitates on-site and on-demand production of PAA and that has many advantages over prior methods and compositions.

Various processes for producing nonequilibrium peroxycarboxylic acids, such as nonequilibrium peracetic acid are provided. The production is particularly useful for on-site production of nonequilibrium peracetic acid. Generally in embodiments of the present invention nonequilibrium PAA is produced by reacting a properly chosen acyl donor, preferably acetyl donor, with hydrogen peroxide to produce nonequilibrium peroxycarboxylic acid. The composition of the acetyl donor source for use in a commercial reactor system may be composed of an acetyl donor compound, optionally containing more than one type of acetyl donor compound, optionally containing an electrolyte salt, optionally containing a peroxide stabilizer, optionally containing a base, optionally containing an acid, optionally containing a solvent (water, alcohols, organic). The acyl or acetyl donor is chosen so that that the reverse reaction is not possible or has a very slow rate. Thus, acetic acid (or other carboxylic acid) itself is not a preferred acetyl donor. Examples of acetyl donors include, but are not limited to, O-acetyl donors (—O—C(O)CH₃), such asacetin, diacetin, triacetin, acetylsalicylic acid, (β)-D-glucose pentaacetate, cellulose (mono and tri) acetate, D-mannitol hexaacetate, sucrose octaacetate, and acetic anhydride. N-acetyl donors (—N—C(O)CH₃) may also be used, such as N,N,N′N′-tetraacetylethylenediamine (TAED), N-acetyl glycine, N-acetyl-5 DL-methionine, 6-acetamidohexanoic acid, N-acetyl-L-cysteine, 4-acetamidophenol, and N-acetyl-Lglutamine.

The solutions produced, including peracetic acid solutions, have nonequilibrium compositions, such as characterized by high peroxycarboxylic acid (POA) and water to carboxylic acid (CA) and hydrogen peroxide (H₂O₂) ratios. In an aspect, the ratio of [POA][H₂O]/[CA][H₂O₂] is ≧10, ≧100, ≧1000, ≧10,000. In another aspect the ratio of [POA]:[H₂O₂] is: ≧1, ≧5, ≧10, ≧100, when the [POA]:[CA] concentration ratio is ≧1.

More specifically, peracetic acid solutions of this invention have nonequilibrium compositions such as characterized by high peracetic acid (PAA) and water (H₂O) to acetic acid (AA) and hydrogen peroxide (H₂O₂) ratios. In an aspect, the ratio of [PAA][H₂O]/[AP][H₂O₂] is ≧10, ≧100, ≧1000, ≧10,000. In another aspect the ratio of [PAA]:[H₂O₂] is: ≧1, ≧5, ≧10, 100 when the [PAA]:[AA] concentration ratio is 1. The nonequilibrium PAA solutions are economically competitive to equilibrium peracetic acid solutions commercially produced (“merchant”) and having typically maximum weight peracetic acid content of between 5% and 35%, where [PAA][H₂O]/[AA][H₂O₂] ratios are typically between 1.8 and 2.5.

A particular advantage of the use of nonequilibrium peroxycarboxylic acid is that solutions having concentrations of less than about 10 g/L peroxycarboxylic acid can be produced economically. This is particularly the case with nonequilibrium PAA. For example, making dilute solutions (<10 g/L) of equilibrium PAA is not cost-effective because in dilute solutions equilibrium favors the formation of hydrogen peroxide and acetic acid over PAA requiring high ratios of feed chemicals to obtain the desired PAA product at low concentration. Therefore, the cost of feed chemicals is much lower for nonequilibrium PAA relative to equilibrium PAA at low concentrations of PAA. Another advantage of nonequilibrium peroxycarboxylic acid is that the feed chemicals (hydrogen peroxide and acyl donor (or acetyl donor)) are significantly less hazardous than those of high concentration equilibrium solutions. This results in safer storage and handling for the end user.

One aspect of this invention provides a method for producing a nonequilibrium peroxycarboxcylic acid solution by a process comprising:

a. diluting aqueous hydrogen peroxide solution with softened or deionized water to a concentration less than 10% (w/w), preferably less than 6% (w/w)

b. adding alkali metal hydroxide or alkali earth metal hydroxide, or solutions of alkali metal hydroxide or alkali earth metal hydroxide to adjust the pH of the resulting peroxide mixture to between 10 to 13.5.

c. thirdly adding a suitable O-acetyl or N-acetyl donor such that the ratio of peroxide to acetyl group in the reaction mixture is at least 1, more preferably 1.5 or greater.

d. mixing the components vigorously and for a sufficient time for the two phase mixture to change into a single phase solution, indicating a nearly complete reaction

e. optionally adding an acid source to the reacted mixture to adjust the mixture pH

f. optionally adding additional peroxide to the reacted mixture to augment the mixture's peroxide component.

In an embodiment of the present invention, the O-acetyl donor is triacetin.

In another embodiment, a system for the point of use manufacture of PAA is provided in which the vigorous mixing is produced by an inline static mixer producing a high shear/highly turbulent flow having a Reynolds number of 500 or greater.

In yet another embodiment, optimum instantaneous reaction times are attained by selectively controlling the mixing order of the reaction components and vigorously mixing the reaction solution following the addition of each reaction component.

In still another embodiment, the optionally added acid source is added to the reaction solution at a residence time of approximately 2 to 30 seconds followed immediately by an intense mixing of the mixture to produce a total fluid flow having a Reynolds number in a range of approximately 500 to approximately 10,000, whereby the pH of the mixture is reduced to 7 or less.

In another embodiment, the system for the point of use manufacture of PM includes a plurality of water-powered proportional pumps connected in series, thereby enabling the system to be operated without electrical power in a remote location or in the event of a power failure.

In yet another embodiment, the point of use manufacturing system includes at least one redundant manufacturing system in parallel with the primary point of use manufacturing system.

In still another embodiment, the hydrogen peroxide content in the reaction product is selectively controlled to minimize environmental contamination thereby without affecting the manufacture of the reaction product

In a further embodiment the manufacturing system includes a mechanism for removing the exothermic heat generated during the manufacturing process; whereby the efficiency of the manufacturing process is enhanced.

In another embodiment, the reaction product is produced without the addition of a stabilizer, whereby the environmental impact of reaction product is minimized.

The foregoing has outlined rather broadly the features and technical advantages of embodiments of the present invention in order that the detailed description of embodiments of the invention that follows may be better understood. The above and other embodiments and features of this invention will be still further apparent from the description, the accompanying drawings, and/or the appended claims. Additional features and advantages of embodiments of the invention will be described hereinafter that form the subject of the claims. It should be appreciated by those skilled in the art that the conception and the specific embodiments disclosed may be readily utilized as a basis for modifying or designing other structures for carrying out the same purposes of embodiments of the present invention. It should also be realized by those skilled in the art that such equivalent constructions do not depart from the spirit and scope of embodiments of the invention as set forth in the appended claims.

### BRIEF DESCRIPTION OF THE DRAWINGS

The drawings, which are incorporated herein, illustrate one or more embodiments of the present invention, thus helping to better explain one or more aspects of the one or more embodiments. As such, the drawings are not to be construed as limiting any particular aspect of any embodiment of the invention. In the drawings:

FIG. 1 is a flow and block diagram of the flow path of feedstock through and components of a system for the point of use manufacture of PAA, elements of its control system, and reactant sources in an embodiment of the device in which water, peroxide, hydroxide, and an acyl donor provided from respective individual sources are mixed in a specific order to produce a peroxycarboxcylic acid solution with a controlled peroxycarboxcylic acid concentration at the outlet.

FIG. 2 is a flow and block diagram of the flow path of feedstock and components of a system for the point of use manufacture of PAA, control system components, and reactant sources in an embodiment of the device in which water, peroxide, hydroxide, an acyl donor, and acid provided from respective individual sources are mixed in a specific order to produce peroxycarboxcylic acid solution with a controlled pH, concentration of peroxycarboxcylic acid, and concentration of peroxide at the outlet.

### DETAILED DESCRIPTION OF THE INVENTION

The order of elements in this sequence, the concentrations described, the values of pH, the mixing conditions, and the concentration ratios described herein and controlled by the described system are unique features of embodiments of the present invention, enabling the rapid, safe, and economical on-site production of nonequilibrium peroxycarboxcylic acid solutions by the system. Dilution of either the peroxide to less than 10% (w/w) with water prior to mixing with a source of hydroxide, or alternatively, the source of hydroxide prior to mixing with a source of peroxide, prevents formation of an explosive mixture and is therefore important for the safe operation of the system. The adjustment of pH of the peroxide solution to within the range of 10 to 13.5 prior to addition of the acyl donor causes the peroxycarboxcylic acid formation reaction to proceed at a higher rate than at pH values outside this range. However, the rate of the decomposition reaction of the peroxycarboxcylic acid increases with increasing pH. Control of pH prevents the decomposition reaction from limiting yield. Rapid formation of the peroxycarboxcylic acid is desirable for on-demand applications. When the ratio of peroxide to acyl group in the reaction mixture is at least 1, the sequence produces peroxycarboxcylic acids with the most efficiency with regard to conversion of starting materials. Efficient conversion of starting materials is desirable for economical production of peroxycarboxcylic acids.

The pH of the reacted mixture exiting from the mixing mechanism, measured by a pH probe in the system, may not be at the desired pH for a given application. Therefore, acid or hydroxide sources may be added to the mixture prior to dispensing, to adjust the pH to make the dispensed solution suitable for a given application. In a similar manner, a peroxide source may be added to the mixture prior to dispensing, to increase the ratio of peroxide to peroxycarboxcylic acid to be suitable for a given application.

As used herein, the term “about” modifying the quantity of an ingredient or reactant of embodiments of the invention employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and similar. The term “about” also encompasses amounts that differ due to different equilibrium conditions for a composition resulting from a particular initial mixture. Whether or not modified by the term “about”, the claims include equivalents to the quantities.

As used herein, “comprising” is synonymous with “including,” “containing,” or “characterized by,” and means the presence of the stated features, integers, steps, or components as referred to in the claims, but it does not preclude the presence or addition of one or more other features, integers, steps, components or groups thereof. The term is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. The broad term comprising is intended to encompass the narrower consisting essentially of and the even narrower consisting of. Thus, in any recitation herein of a phrase “comprising one or more claim element” (e.g., “comprising A and B), the phrase is intended to encompass the narrower, for example, “consisting essentially of A and B” and “consisting of A and B.” Thus, the broader word “comprising” is intended to provide specific support in each use herein for either “consisting essentially of” or “consisting of.” The invention illustratively described herein suitably may be practiced in the absence of any element or elements, limitation or limitations which is not specifically disclosed herein.

As used herein, the term “peracid” is synonymous with peroxyacid, peroxy acid, percarboxylic acid and peroxoic acid. As is commonly known, peracid includes peracetic acid.

As used herein, the term “peracetic acid” is abbreviated as “PAA” and is synonymous with peroxyacetic acid, ethaneperoxoic acid and all other synonyms of CAS Registry Number 79-21-0.

As used herein, the term “nonequilibrium” refers to chemical mixtures that do not provide equilibrium constant value, such as those determined by Equation (2A) for peroxycarboxylic acids in general, or by Equation (2B) for peracetic acid solutions. Accordingly, a nonequilibrium PAA solution is optionally described as having an equilibrium constant typically as calculated by Equation (2) that is not between 1.8 and 2.5. In an aspect, the nonequilibrium PAA is defined as those solutions having an equilibrium constant of greater than 10, greater than 100, greater than 1000, and greater than 10,000. As used herein, in certain aspects “nonequilibrium peracetic acid solutions” refer to PAA solutions having equilibrium constants greater than 10, greater than 100, greater than 1000, and greater than 10,000.

“Acyl donor” refers to a material which supplies an acyl donor for reacting with the hydrogen peroxide or peroxide ions to form a solution which includes a peroxycarboxylic acid. In a specific embodiment, an “acyl donor” refers to a material which supplies an acetyl donor for reacting with the hydrogen peroxide or peroxide ions to form a solution which includes peracetic acid. “Acetyl donor” refers to a material which supplies an acetyl donor for reacting with the hydrogen peroxide or peroxide ions to form a solution which includes a peroxycarboxylic acid. In an embodiment, an acetyl donor refers to a material which supplies an acetyl donor for reacting with the hydrogen peroxide or peroxide ions to form a solution which includes peracetic acid.

As used herein, “sufficient mixing” means mixing that causes a two-phase mixture of acyl donor and aqueous peroxide solution to become a one-phase flow within the residence time in the mixer or mixing tank. The residence time is defined as the volume flow rate of mixture entering the mixer or mixing tank with respect to time divided by the volume of the mixer or mixing tank.

The term “triacetin” is synonymous with glycerin triacetate; glycerol triacetate; glyceryl triacetate, 1,2,3-triacetoxypropane, 1,2,3-propanetriol triacetate and all other synonyms of CAS Registry Number 102-76-1.

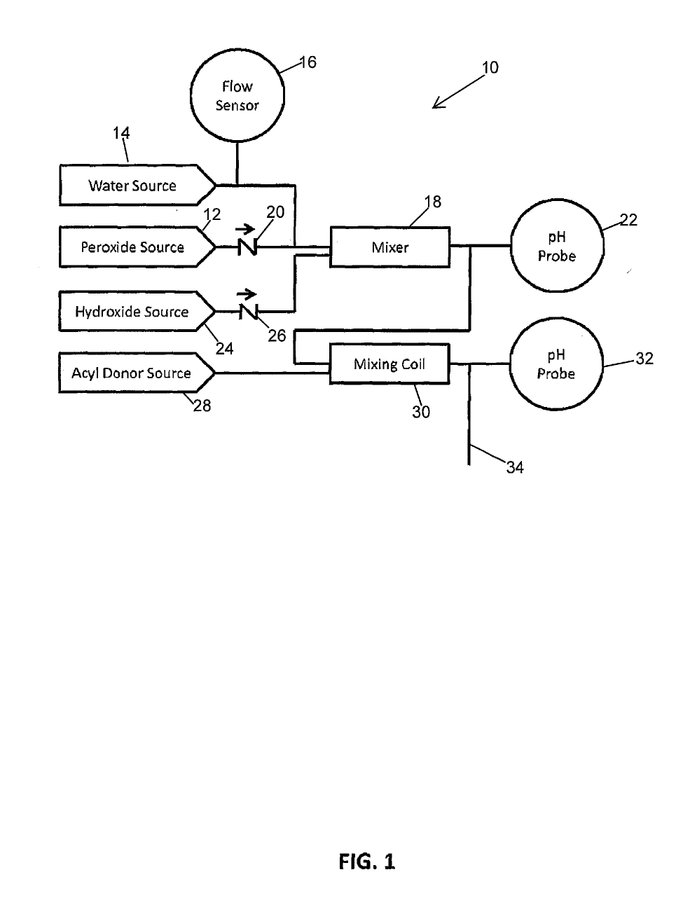

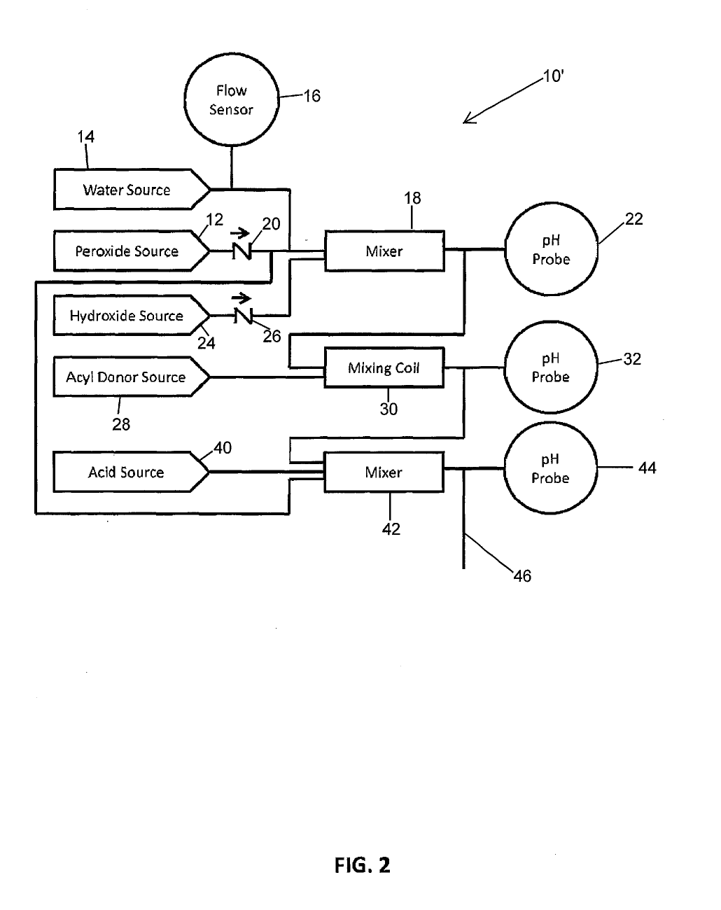

Flow-charts of exemplary processes of the invention for production of PAA are provided in FIGS. 1-2.

Referring to FIG. 1, a system 10 for the point of use manufacture of PAA and the flow of reactants and end product therethrough are shown. The product mixture is prepared by first diluting hydrogen peroxide (“HP”) feedstock received from a peroxide source or holding receptacle 12 to a concentration less than 10% (w/v) and having a pH of less than 7.0 by mixing with water stored in a water source or tank 14. Flow meter 16 monitors the water flow rate from the source into a mixer or mixing tank 18, and a one way flow control valve 20 selectively controls the flow of peroxide from source 12 into the mixer. The pH of the solution in the mixer is monitored by a pH probe 22 and is then adjusted to 11.5-13.5 by addition of alkali metal hydroxide (preferably NaOH, or KOH) from a hydroxide source or storage reservoir 24 via one way flow control valve 26 to maximize the ratio of —OOH to —OH in the reaction mixture. The pH at this step is also optimized to have enough alkalinity to result in a product mixture where pH remains above 9 after the base-consuming reactions are complete. The diluted, alkaline peroxide solution is then reacted with a suitable O-acetyl or N-acetyl peroxide activator. Preferably, the activator is non-toxic, non-flammable, and has kinetically rapid reactivity with peroxide. More preferably, peroxide activator is monoacetin, diacetin, or triacetin. The stoichiometry of —OOH to acetyl group is controlled to result in high selectivity for PAA production over acetic acid, or alternatively to result in a product mixture with a specified remaining peroxide concentration, which may be desirable for certain applications.

The ratio of —OOH to acetyl group is controlled to result in a product mixture with a specified remaining concentration of —OOH. For example, if that ratio is 1:1, there will be very little peroxide remaining in the product mixture. If the ratio of —OOH to —OH is 2:1 then after reaction, the mixture will have slightly more than 1-fold peroxide remaining after reaction. If the —OOH to —OH ratio is 10:1, there will be slightly more than 9-fold peroxide to PAA in the resulting peroxide mixture.

The chemical properties can be further manipulated after reaction by augmentation of peroxide, or pH adjustment by addition of acidic components, making the mixture more stable. Acids may include, but are not limited to, sulfuric acid, acetic acid, citric acid, nitric acid for food surface application, for example.

The reaction components may be combined in individual batches or may be combined using a continuous process.

Non-limiting alternate embodiments, procedures, or methods of construction, include addition of HP after the reaction; adjustment of the pH post reaction; intentional under-stoichiometry reaction between —OOH and acetyl group to produce a product with minimal HP in the product composition; and using peroxide activators other than triacetin. For example, an acyl donor may be delivered from a holding container 28 into a second mixer or mixing coil 30 where it is mixed with the solution delivered from mixer 18. A second pH probe 32 monitors the pH of the solution in mixer 30 as it is adjusted to a desired level, whereupon the final product is discharged via discharge outlet 34.

### SPECIFIC EXAMPLES

### Example 1

88.2 mL of ˜34% (w/w) hydrogen peroxide was diluted to 1000 mL in deionized water. The hydrogen peroxide concentration was determined to be 3.40% and the pH was 3.99. 100 ml of this diluted HP solution was placed in a 150 ml beaker equipped with a magnetic stir bar. NaOH (1.82 g) was added to the stirred solution, raising the pH to 12.51. Titration indicated the concentration of the alkaline peroxide solution to be 3.35%. To this solution, triacetin (3.09 ml, 2-fold excess HP to acetyl group) was added and the mixture was stirred vigorously for 10 min. After 10 min. the mixture pH had dropped to 10.64. The remaining concentration of HP was determined to 1.68% and the PAA concentration was 2.87%.

### Example 2

88.2 mL of ˜34% (w/w) hydrogen peroxide was diluted to 1000 mL in deionized water. The hydrogen peroxide concentration was determined to be 3.43% and the pH was 4.28. 100 ml of this diluted HP solution was placed in a 150 ml beaker equipped with a magnetic stir bar. NaOH (2.13 g) was added to the stirred solution, raising the pH to 12.48. Titration indicated the concentration of the alkaline peroxide solution to be 3.37%. To this solution, triacetin (3.1 ml, 2-fold excess HP to acetyl group) was added and the mixture was stirred vigorously for 10 min. After 10 min. the mixture pH had dropped to 11.23. The remaining concentration of HP was determined to 1.00% (w/w) and the PAA concentration was 3.06%.

Concentrated H₂SO4 (98%, 18.4 M) was added (1.5 ml) to the stirred mixture, dropping the pH to 3.01. The temperature of the mixture increased to 36° C. during pH adjustment. The concentration of hydrogen peroxide in the product was found to be 0.90% and the concentration of PAA was 2.74%.

### Mixing Apparatus and Techniques:

During the course of investigating and developing the system and methodologies of the present invention as herein disclosed, the reaction was found to be most efficient when the relative amount of HP exceeded the relative amount of triacetin. Triacetin is relatively insoluble in water and remains in a separate phase for several minutes after it is introduced, generally in the form of strands and globules. When the HP is introduced and the pH raised to initiate the PAA forming reaction, the reaction occurs at the external boundaries of the triacetin strands and globules, which results in the following reaction inefficiencies.

First, in the localized area of the reactions at or near the surface of the triacetin strands and globules, a very high concentrations of triacetin and a relatively low concentrations of HP exist, inasmuch as the HP has been consumed by the initial earlier reaction with the triacetin. As noted above, the reaction is most efficient when the relative amount of HP exceeds the relative amount of triacetin. Accordingly, the efficiency of the reaction is noticeably decreased as a result of the low ratio of HP to triacetin.

Secondly, most of the triacetin is found within the strands and globules where it is not in contact with and therefore not reacting with the HP. As a result, the time required to make the PAA is significantly increased and has been found experimentally and reported by others (EP Patent No. 2688399 B1 issued to EnviroTech Chemical Services on Nov. 4, 2015) to fall in the range of 30 seconds to two minutes, an unacceptably long time for practical point of use applications.

By ensuring that the triacetin is dissolved fully in the water before introducing the HP and the alkali metal, for example, NaOH, the reaction time may be reduced significantly to 15 seconds or less, thereby realizing several benefits: 1) the generator apparatus is simplified and less expensive because less residence time internally translates into lower equipment requirements to hold the reactants during the reactions; 2) more efficient reactions translate into more PAA produced for the same amount of input feedstock; 3) the amount of evolved gas (O₂ and CO₂) is decreased significantly resulting in an increased stable and steady output flow uninterrupted by gurgling and sputtering at the flow output of prior art systems resulting from the emergence of large gas bubbles; 4) the time lapse between turning on the PAA generator and the production of PAA product is decreased significantly, a parameter of high importance in point of use applications where, in a situation analogous to a vending machine, the user expects a turn-key operation and instantaneous production of product; 5) reduction in heat generation and corresponding reaction-destroying temperature rise in the water; and 6) a substantial reduction in wasted material produced in an intermittent generator which rapidly decays and must be discarded, frequently in quantities greater than the quantities of usable product.

Various methods may be employed to fully dissolve triacetin in water. One method involves heating the triacetin-water mixture which increases the quantity of dissolved triacetin. However, as described above, heat reduces the efficiency of the PAA reaction and is relatively costly, and if the temperature drops, a portion of the dissolved triacetin comes back out of solution in the form of undesirable strands and globules. However, as will be discussed below in greater detail, increased reaction product concentrations may be attained by removing some of the heat generated by the reactions.

A second method involves pre-dissolving traicetin in water outside the generator using time and mixing to eliminate the strands and globules. This approach requires a significant amount of extra water to be supplied to the generator, since at room temperature, the maximum amount of triacetin that can be dissolved is only approximately 4%.

A third approach entails the use of a mixing device which generates significant shear and/or turbulence in the solution to dissolve the triacetin in the water in the generator. Various types of mixing apparatus can be used in the practice of this invention. Several embodiments are considered that differ in the type of mixing mechanism used to mix the stream after the streams of the peroxide source, the hydroxide source, the acyl donor, and the diluting water are combined. A continuous mixing tank with agitation may be used, to which the components are added and from which the product stream is removed, continuously. In this embodiment, the product stream may contain unreacted components. Also, reactants are added to the tank containing a solution that is substantially the same as the desired product stream, in which the pH and reactant concentration ratios are not ideal for producing with the highest yield. The pH of the mixture contained in a small volume decreases as the reaction to form a peroxycarboxcylic acid proceeds. Several approaches and apparatus may be used to carry out the mixing. Approaches include active mixing, passive mixing, induction, and injection methods. Apparatus effective in this invention include mechanically stirred tanks, centrifugal mixers, centrifugal pumps, static mixers, eductors, venturi mixers, and injector tubes and nozzles. Reaction components may be introduced to such apparatus by means of dosing pumps, metering pumps, peristaltic pumps, gravity feed, solenoid valve feed, rotary valve feed, and pressure driven feed mechanisms utilizing pneumatic or hydraulic driving forces. The mixture of alkaline hydrogen peroxide and acetyl or acyl donor is provided a reaction time (also called residence time or dwell time or cure time) in the mixing apparatus that allows the formation of the peroxyacetic acid product to occur. The reaction time is preferably adjusted to maximize peroxycarboxylic acid yield prior to pH adjustment, stabilization or use.

Alternatively, a batch mixing tank with agitation may be used, to which the components are added and from which the product stream is removed, after sufficient reaction time. In this embodiment, the product stream will contain fewer unreacted components and the pH and reactant concentration ratios will be close to those ideal for the best product yield. However, this embodiment may be impractical for an on-demand production application.

Alternatively, a series of mixing tanks, where the contents of each tank is continuously drained and used to fill the succeeding tank or removed as the product stream, may be used. In this embodiment, the conditions in each mixing tank will be closer to ideal for the stage of the reaction contained in each tank. The reactants in this embodiment may also move through the embodiment with an average flow rate that is practical for on-demand applications.

Another preferred mixing apparatus comprises a mixing vessel equipped with a mechanical stirrer. In this case, the mixing vessel continuously receives the feed streams of reactants, and either continuously or intermittently discharges a product mixture formed from these feed streams. The mechanical stirrer can be programmed to operate continuously or intermittently as long as the discharged product mixture is of desired composition. For instance, if the discharge is continuous, the system is designed and constructed such that the total incoming volume to the mixing vessel and the concurrent outgoing volume from the vessel remain equal and so that the vessel continuously contains a predetermined volume of contents which are being mixed by the mechanical stirrer. In such case, the stirrer preferably is operated continuously.

In one preferred embodiment the mixing apparatus comprises a static mixer. The static mixer can be of any suitable design and configuration as long as it is capable of continuously receiving the feed streams of reactants, and continuously discharging a product mixture formed from these feed streams that is substantially uniform in composition and/or satisfies product specifications. An exemplary static mixer of the type herein contemplated is disclosed in U.S. Pat. No. 5,839,828 issued to Robert Glanville on Nov. 24, 1998. However, it is to be understood that other static mixer configurations may be used without departing from the scope of the present invention.

Alternatively, a static mixer with sufficient volume relative to the volume flow rate to provide a sufficient reaction time may be used. The static mixer may consist of a mixer followed by a continuous tube reactor constructed from pipe or tube. This embodiment provides sufficient mixing and a continuous flow of reactants and product suitable for on-demand operation. In this embodiment, passing the mixed components through a mixer of suitable length and volume to ensure a residence time of the components within the mixer of sufficient time for the two-phase mixture to form into a single phase solution allows sufficient time for the peroxycarboxcylic acid formation reaction to proceed mostly to completion, due to the plug nature of the flow of components in the mixer.

One unexpected benefit of the static mixer is a rapid reaction of the mixture to form peracetic acid when a mixing coil or small mixing tank is used instead of a large mixing tank, as would be used to store the daily product of the process. When the reaction was tested in small volume mixing containers at the bench scale, in batch mixtures, increased agitation of the mixture lead to faster reaction times. This is due to the low rate of dissolution of triacetin in the aqueous solution of peroxide and hydroxide. Increasing the agitation increases the homogeneity of the mixture, allowing greater surface area of the triacetin volume in the mixture, allowing a faster reaction rate. This benefit would be expected from correctly sized static mixers and tube reactors that provide sufficient agitation for bubbles of undissolved triacetin or other acyl donor to be small in size.

In practice, it has been observed that an inline static mixer of sufficiently small size produces the best results. Preferably, the inline static mixer has a diameter small enough to cause the liquid flow to be at a Reynolds number of 500 or greater to sufficiently break the triacetin into very small particles which totally or nearly totally dissolve in the water.

In another embodiment, the tube reactor may have two different diameters along its length. The first segment of the mixing coil that the mixture passes through has a smaller diameter and a more turbulent flow. This encourages thorough mixing of the mixture. The second segment of the mixing coil that the mixture passes through has a larger diameter, allowing the thoroughly mixed mixture sufficient time to react in a shorter distance of tubing.

### Mixing Order:

Another approach to maximizing the dissolution or triacetin in the PAA-generating reagent mixture is to mix the solution multiple times. This may be accomplished by adding the triacetin to water and then sequentially adding the caustic and the HP, thus ensuring that the traicetin passes through three mixers. However, the traicetin and the alkali earth metal begin reacting with one another in an undesirable side reaction, however briefly, before the HP is introduced. However, as illustrated in FIG. 2, a preferred approach is to add the triacetin to water and mix; then add the HP from source 12 and mix again in mixer 18; and finally add the alkali earth metal (the caustic) from reservoir 24 and mix a third time. No precursors are used and each mixing step occurs for less than ¼ second before the next mixing step begins.

### Optimal Reaction Quench:

Using the processes as herein disclosed, HP and triacetin (or some other acetyl donor) are reacted in water wherein the pH has been raised to approximately 12.5 by the addition of an alkali earth metal (typically NaOH or KOH). The amounts of HP and triacetin determine the PAA concentration in the alkaline water which may range from 10 ppm to 6% or greater. Several competing reactions take place in the alkaline environment. One reaction is the reaction of the HP and triacetin to make PAA, and the other is the self-destruction of the PAA into acetic acid and O₂. In a well-mixed system, the PAA concentration varies significantly with time. Within a second or two of initiation of the reaction, the PAA concentration is typically approximately 60% of theoretical maximum, and after about ten seconds, it is at approximately 75-80% of theoretical maximum. Thereafter, the concentration begins to decline as the PAA self-destructs.

Most PAA applications require that the PAA be acidic, that is to have a pH less than 7. However, none of the above-described reactions occur to any significant extent in an acidic environment, the reaction pH being approximately 12.5. Accordingly, the reaction and product degradation may be advantageously stopped by adding an acid which quenches the reaction and results in an acidic product. This process is illustrated in FIG. 2 wherein an acid injection from an acid source after a residence time of 2-30 seconds followed immediately by mixing with a static mixer 42 as described above with a resident time of less than % second in a housing with an inside diameter sufficiently small to produce a fluid flow having a Reynolds number between 500 and 10,000 attains the desired results. As described above, the pH of the solution is monitored throughout this quench process by a pH probe 44. The final product is discharged via discharge outlet 46

### System Configurations:

### Water-Powered Proportional Pumps:

Typically, each of the chemical reactants is delivered by a separate conventional feed pump. However, using water-powered proportional pumps connected in series provides a significant reduction in system complexity, eliminates the need for electrical power for pump operation and system control, and reduces significantly the number of valves required in the system. Proportional pumps inherently contain controls for all of the feedstock chemicals, thereby eliminating the need for separate flow measurement devices, flow controllers, flow control valves, relief valves and the like. The substantial reduction in the number of threaded connections minimizes the number of potential leakage and system failure points. While these types of pumps have certain disadvantages such as more moving parts, uneven flow rates and larger size, they permit operation of a point of use PAA generating system where electricity is not available (such as at a remote location) or during power outage situations such as a water treatment plant where continuing PAA production may be crucial.

### Multiple Parallel Systems:

A characteristic of the PAA generator is that if any of the three chemical feed pumps (hydrogen peroxide, sodium or potassium hydroxide and triacetin or another acetyl donor) fail, no PAA is made. Thus, from a back-up perspective, it makes no sense to continue to run the other two pumps if one fails. By providing multiple backup systems in parallel, a minimum of one parallel system and preferably two may be provided, if any one pump in one of the parallel systems fails, that system may be completely shut down for repairs and another set of three pumps may be brought online to ensure continuity of PAA production.

Several advantages using this approach may be realized. First, the number of manual and actuated valves required for operation is reduced significantly, and the control system, being built into the pumps, is much simpler. Compared to individual back-up pumps, this approach also means many fewer screwed connections which significantly reduces the chances of leakage from the unit. Thirdly, the primary mixing/reaction system is duplicated. If for whatever reason the requirements on the system exceed what one line can produce, the second (or third) set of pumps can be brought online to handle the increased requirements. In this way the back-up pumps also act as a way of producing significantly more than system rated output for a short or even extended period of time.

### Odor Removal Via Increased pH of Equilibrium PAA:

As discussed above with respect to prior art systems, conventional production methods for PAA involve mixing acetic acid with hydrogen peroxide in water with a small amount of acid present (typically sulfuric acid) for roughly a week. This mixture reaches equilibrium with much of the HP and acetic acid remaining in the mixture with some PAA. The pH of this mixture is a function of the concentration of both the acetic acid and the HP, but typically 15% PAA has a pH of less than 1 and PAA diluted to 1% has a pH of about 3.

Sometimes it is desirable to remove the very strong odor of the final equilibrium PAA product, such as when it is used indoors. Anti-microbial efficacy is roughly the same whether the PAA is in an acidic or alkaline state. The two most significant differences are: 1) alkaline PAA has no odor and 2) alkaline PAA self-degrades very rapidly when the pH is above 8, usually at 5-10% per hour. In situations where the PAA is to be used within minutes or hours of when it is made alkaline, the addition of an alkali earth metal in solution with water can be used alone or with more water to both dilute the PAA and raise its pH to any desired level, eliminating its odor. At this point other materials may be added to the alkaline PAA such as detergents, fragrance additives and even foaming agents.

### Pump-Less PAA Generator:

Certain applications for a PAA generator exist where it is desirable to reduce complexity to a bare minimum and to minimize the number of moving parts in the production system that can either break or require maintenance. These systems are not as flexible as those with variable rate pumps, but they greatly reduce costs and complexities of the systems.

An example of this type of application is a generator that would go under the sink in a home, a restaurant or other facility where PAA sanitation is required. Accordingly, two embodiments of the PAA generator are provided which do not use pumps in the production process.

In one embodiment, three bladders are provided, each of which contains one of the three feed chemicals (hydrogen peroxide, triacetin and an alkali earth metal such as sodium or potassium hydroxide). The bladders are positioned in a housing to which pressurized incoming water is delivered externally to the bladders, whereby they are each compressed by the water pressure. When a valve is opened to let the water out (such as a spray nozzle in a kitchen sink) the water flows out at a pre-selected rate. The three bladders, each of which is open to the pressurized water via small orifices formed therein, will have some of the chemical in the bladders forced out into the water. By proper sizing of the orifices, the quantity of each of the chemicals forced from the bladders may be controlled to react with each other in the water stream.

Another embodiment uses venturi eductors to use the water pressure to pull each of the chemicals into the water stream for the reaction to occur. Control is achieved by controlling the water pressure and/or restricting (or not) the chemical flow to the eductors.

### Tunable HP Content:

Equilibrium PAA is presently made and sold in various concentrations of PAA and various concentrations of leftover hydrogen peroxide and acetic acid. The amounts of each are based on standard equilibrium chemistry which means that the concentrations are determined by the relative amounts of hydrogen peroxide and acetic acid at the start of the reaction. One key factor is that a significant amount of hydrogen peroxide always remains in the PAA product.

The non-equilibrium PAA generated in accordance with the methods of the instant invention is based upon the reaction of hydrogen peroxide as a feed chemical with triacetin in a caustic environment. This reaction differs from the reaction that produces equilibrium PAA. The amount of hydrogen peroxide relative to the amount of triacetin determines the quantity of hydrogen peroxide remaining after the reaction, if any. As long as sufficient hydrogen peroxide is available to react with the triacetin, the triacetin is totally consumed.

The methodologies disclosed herein provide the capability to adjust the PAA content of the PAA reaction product. At current feed prices, the cost to manufacture PAA is lowest when a slight excess of HP in the feed exists that results in an excess HP of about 0.40 lb./lb. PAA. However, in some applications such as wastewater treating it is desirable to have a minimum amount of HP left over to go into the environment. There are other applications such as pulp and paper processing where excess HP assists in bleaching the pulp and paper.

Two methods for controlling HP content in the product relative to the PAA concentration are disclosed in accordance with the present invention. First, the ratio HP to triacetin in the feed can be adjusted to give product ratios of HP to PAA ranging from very little (around 0.05) to about 5.0 lb of HP per pound of PPA. The advantage of this method is that as the feed HP to triacetin ratio increases, triacetin selectivity with respect to PAA increases. The disadvantage of this method (relative to the embodiment discussed below) is that all production from the generator has this same ratio.

The second method is to put just enough HP through the generator to make the PAA (for example at a ratio of about 0.4 lb. HP/lb. PAA for efficient generation) and then bypass HP around the generator and put it in the product to increase the HP to PAA ratio to whatever is desired. This approach requires extra hardware and controls versus the previous method. However, if multiple product streams are coming from the generator, this method allows the opportunity to have different HP:PAA ratios in each stream.

There are some versions of PAA on the market that have lower HP:PAA ratios such as EnviroTech's Persan MP-2 and PeroxyChem's VigorOx 15% that have HP:PAA ratios of 0.40 to 0.67. However, these are equilibrium PAA products, and to attain these low HP contents, they have correspondingly high levels of acetic acid (2.33 lb. acetic acid/lb. PAA) versus the more typical amounts (˜1.0 lb. acetic acid/lb. PAA). The reaction product made in accordance with the procedures disclosed herein contains extremely small amounts of acetic acid, so this is not a concern. Moreover, it provides total flexibility of HP content which may be selectively changed “on the fly” with no consequences related to acetic acid production.

### Higher Concentration via Improved Mixing and Heat Removal:

The reaction of hydrogen peroxide (HP) with triacetin in a caustic water environment is exothermic and gives off heat which then shows up as a temperature increase in the water solution temperature. At 1.5% PAA concentration, the solution temperature increases from about 20° C. to about 40° C. Increasing the concentrations of triacetin and HP in the feed causes more reaction in the same amount of water which causes the temperature to increase further. This temperature increase above 40° C. causes a number of problems within the generator, not the least of which is the self-destruction of the PAA just made which lowers unit efficiency and also causes more gas evolution which then lessens heat transfer out of the reaction system, further aggravating the temperature problem.

Use of high shear and/or high turbulence mixers on each feed entering the water, especially for the triacetin to ensure it is dissolved in the water and/or dispersed in very small globules, increases the amount of HP present at the point of reaction, inasmuch as the reaction is not restricted to occurring at surface of larger triacetin globules. This helps to minimize reactions which produce the large gas bubbles which cause hydraulic problems in the units and also interfere with heat removal.

Heat removal can be applied to hold the temperature of the reaction water to 40° C. or less. This heat removal can be performed with finned tubes with air moved across the tubes via convection or blowers (similar to an automobile radiator) or it can be done via a conventional heat exchanger using liquid to transfer the heat out of the heat exchanger system. By holding the temperature to 40° C., PAA with a concentration in excess of 5% with an efficiency similar to efficiencies at 1.5% or less may be generated

### Stabilizer-Free PAA Reaction Product:

Conventional production methods for PAA involve mixing acetic acid with hydrogen peroxide in water with a small amount of acid present (typically sulfuric acid) for roughly a week. This mixture reaches an equilibrium state having much of the HP and acetic remaining in conjunction with some PAA. This mixture is typically sold at 5%, 5.6% or 15% although many other concentrations are available. The equilibrium mixtures do not further change composition with time, hence the label “equilibrium PAA”). However, vendors sometimes do not sell or use the PAA immediately and most guarantee that the composition will hold for at least a year.

Although the solution doesn't undergo any further shift equilibrium, both PAA and HP are very strong oxidizers and will react with many substances such as dissolved iron or copper in the water, the walls of some storage containers, etc. To prevent this from occurring, PAA manufacturers use a stabilizer that is a chelating agent to bind the substances that otherwise would react with the PAA and/or HP. Typically this stabilizer is Hydroxyethylidene-1, 1-Diphosphonic Acid, or simply HEDP which is added to the PAA at a 1:20 weight ratio to the PAA. By nature stabilizers last a long time in the environment and, other than sustaining the PAA concentration at a desired level, they have no beneficial effect upon the environment.

The system of the present invention is designed such that the PAA is produced in a unique manner which differs substantially from prior art processes, the end product being inherently not at equilibrium. At 2% concentration, it degrades at about 6% per day if the pH is below 7 (acidic) and at 5-10% per hour when the pH is above 7. Use of a stabilizer will not halt that decay. Accordingly, the system herein disclosed is designed to generate PAA to be used within minutes or hours of when it is made, thereby eliminating the need for a stabilizer used by every other PAA manufacturer in the world.

### ILLUSTRATIVE EMBODIMENTS OF THE PRESENT INVENTION

In an embodiment, there is provided a method for producing non-equilibrium peroxycarboxcylic acid comprising:

a. first diluting aqueous hydrogen peroxide solution with a dilute alkali metal hydroxide or alkali earth metal hydroxide solution to produce a mixture with a hydrogen peroxide concentration less than 10% (w/w), preferably less than 6% (w/w) and a pH between 10 and 13.5.

b. next adding a suitable O-acetyl or N-acetyl donor such that the ratio of peroxide to acetyl group in the reaction mixture is at least 1, more preferably 1.5 or greater.

c. suitably mixing the components for sufficient time to allow complete reaction

d. optionally adding additional dilute peroxide (<35% w/w) to the reacted mixture to augment the mixture's peroxide component

e. optionally adding acid to the reacted mixture to adjust the mixture pH

f. further diluting the mixture with either clean (softened or DI) water or process water to point-of-use biocide concentration.

In an embodiment, there is provided a method for producing non-equilibrium peroxycarboxcylic acid with controlled ratio of peroxycarboxcylic acid to peroxide and controlled pH, the method comprising:

a. providing at least one feed stream comprising a non-equilibrium peroxycarboxcylic acid;

b. supplying at least one source of aqueous peroxide to one or more of the at least one feed stream comprising a non-equilibrium peroxycarboxcylic acid;

c. supplying at least one source of acid or hydroxide to one or more of the at least one feed stream comprising a non-equilibrium peroxycarboxcylic acid and/or the at least one source of aqueous peroxide;

d. varying the volumetric flow rates of the streams of peroxycarboxcylic acid, aqueous peroxide, and acid or hydroxide to provide the a peroxycarboxcylic acid stream with the desired ratio of peroxycarboxcylic acid to peroxide and the desired solution pH.

In an embodiment, there is provided a method for producing non-equilibrium peroxycarboxcylic acid comprising:

a. providing at least one source of water;

b. providing at least one source of aqueous peroxide;

c. supplying one or more of the at least one source of water to one or more of the at least one source of aqueous peroxide to generate at least one source of dilute aqueous peroxide having a concentration of between 0.1% and 10%;

d. providing at least one source of aqueous hydroxide;

e. supplying one or more of the at least one source of aqueous hydroxide with the at least one source of dilute aqueous peroxide to generate at least one source of dilute aqueous peroxide having a pH of greater than 8;

f. providing at least one source of acyl donor;

g. supplying one or more of the at least one source of acyl donor and at least one source of dilute aqueous peroxide having a pH of greater than 8 to a mixing coil or mixer that provides sufficient mixing to produce a single-phase composition of non-equilibrium peroxycarboxcylic acid.

In an embodiment, the stream of non-equilibrium peroxycarboxcylic acid solution is generated by a process comprising:

a. providing a stream of water;

b. using a flow controller or pump to regulate the flow rate of the stream of water;

c. providing a source of aqueous hydroxide;

d. diluting a stream of the aqueous hydroxide by mixing it with water from the water stream;

e. providing a source of aqueous peroxide;

f. mixing a stream of the aqueous peroxide with the stream of diluted hydroxide so that the combined stream has peroxide concentration less than 10% (w/w), and a pH between 10-13.5;

g. providing a source of acyl donor;

h. mixing the stream of diluted peroxide with pH greater than 8 with a stream of the acyl donor in a mixing coil or mixer that provides sufficient mixing to produce a single phase solution comprising non-equilibrium peroxycarboxcylic acid at its outlet.

In further embodiments, the at least one feed stream comprising a non-equilibrium peroxycarboxcylic acid has a concentration below 5.6%, and a source of water is used to dilute one or more of the at least one feed stream comprising a non-equilibrium peroxycarboxcylic acid, the source of aqueous peroxide, and/or the stream of acid or hydroxide.

In further embodiments, a flow controller or pump regulates the flow rate of one or more of the at least one source of water, the aqueous peroxide source is hydrogen peroxide, the acyl precursor is a liquid acetyl precursor, and the acyl precursor is selected from the group consisting of asacetin, diacetin, triacetin, acetylsalicylic acid, (β)-D-glucose pentaacetate, cellulose acetate, D-mannitol hexaacetate, sucrose octaacetate, acetic anhydride, N,N,N′N′-tetraacetylethylenediamine (TAED), N-acetyl glycine, N-acetyl-5 DL-methionine, 6-acetamidohexanoic acid, N-acetyl-L-cysteine, 4-acetamidophenol, and N-acetyl-Lglutamine. In a further embodiment, the liquid acetyl precursor is triacetin.

In further embodiments, the aqueous hydroxide source is an alkali metal hydroxide solution or an earth alkali metal hydroxide solution, the aqueous hydroxide source is a sodium hydroxide solution, and the aqueous peroxide source is hydrogen peroxide.

In an embodiment, there is provided a system for on-site and on-demand generation of non-equilibrium solutions of peroxycarboxcylic acids comprising:

a. a stream of water;

b. a flow sensor placed between said water source and the balance of the system;

c. a first container containing a first solution comprising an aqueous peroxide source;

d. a check valve placed between said aqueous peroxide source and the balance of the system that prevents flow of liquid from the balance of the system in the direction of said aqueous peroxide source;

e. a second container containing a second solution comprising an aqueous hydroxide source;

f. a check valve placed between said aqueous hydroxide source and the balance of the system that prevents flow of liquid from the balance of the system in the direction of said aqueous peroxide source;

g. a third container containing a third solution comprising an acetyl precursor;

h. a pipe or tube manifold with an inlet end accepting flows from said water source and said aqueous peroxide source;

i. a first mixer accepting at its inlet end a diluted aqueous peroxide flow from the outlet of said manifold and flow from said aqueous hydroxide source;

j. a first pH probe that measures the pH of the outlet flow from said mixer;

k. a reactor that accepts at its inlet end the flow from the outlet of said static mixer and said acyl precursor;

l. a second pH probe that measures the pH of the outlet flow from said reactor;

m. a fourth container containing a fourth solution comprising an acidic aqueous solution;

n. a second static mixer accepting at its inlet end the outlet flow from said reactor and said acidic aqueous solution;

o. a third pH probe that measures the pH of the outlet flow from said second static mixer;

p. a control system that accepts electrical signals from said mass flow sensor, said first pH probe, said second pH probe, and said third pH probe, and provides electrical signals to control the speed of a first pumping system pumping said aqueous peroxide source, a second pumping system pumping said aqueous hydroxide source, a third pumping system pumping said acetyl precursor; and a fourth pumping system pumping said aqueous acidic solution;

q. a product tank that collects the outlet flow from said mixing coil.

In further embodiments, the control system stops the operation of the first pumping system and the second pumping system if the mass flow sensor indicates flow of water below a predetermined alarm level; the residence time of the stream in the reactor is sufficient for the two phase mixture to form a single phase solution; the acidic aqueous solution is a sulfuric acid solution; and the acidic aqueous solution is an acetic acid solution.

In an embodiment, there is provided a method for producing non-equilibrium peroxycarboxcylic acid comprising:

a. diluting a solution of aqueous hydrogen peroxide with water to a concentration less than 10% (w/w), preferably less than 6% (w/w);

b. adjusting the pH of the solution to between 11.5-13.5 by adding alkali metal hydroxide or alkali earth metal hydroxide, or solutions of alkali metal hydroxide or alkali earth metal hydroxide;

c. adjusting the ratio of peroxide to acetyl group in the hydrogen peroxide solution to at least 1, more preferably 1.5 or greater by adding a suitable O-acetyl or N-acetyl donor;

d. suitably mixing the components for sufficient time to allow complete reaction;

e. optionally adding acid to the reacted mixture to adjust the mixture pH;

f. optionally adding additional peroxide to the reacted mixture to augment the mixture's peroxide component;

g. further diluting the mixture with either clean (softened or DI) water or process water to point-of-use biocide concentration.

In an embodiment, there is provided a method for producing non-equilibrium peroxycarboxcylic acid comprising:

a. diluting the HP feedstock to a concentration less than 10% (w/v);

b. adjusting the pH to 11.5-13.5 by addition of alkali metal hydroxide (preferably NaOH, or KOH) to maximize the ratio of —OOH to —OH in the reaction mixture;

c. optimized the pH to have sufficient alkalinity to result in a product mixture having pH greater than 9 after base-consuming reactions are complete;

d. reacting the diluted, alkaline peroxide solution with a suitable O-acetyl or N-acetyl peroxide activator that is preferably non-toxic, non-flammable, and has kinetically rapid reactivity with peroxide, and preferably is monoacetin, diacetin, or triacetin;

e. controlling the stoichiometry of —OOH to acetyl group to result in high selectivity for PAA production over acetic acid, or alternatively to result in a product mixture with a specified remaining peroxide concentration, which may be desirable for certain applications;

f. controlling the ratio of —OOH to acetyl group to result in a product mixture with a specified remaining concentration of —OOH;

g. adjusting the chemical properties after reaction by augmentation of peroxide, or pH adjustment by addition of acidic components, making the mixture more stable, where acids may preferably include sulfuric acid, acetic acid, citric acid, nitric acid.

In an embodiment, there is provided a method for producing non-equilibrium peroxycarboxcylic acid comprising:

a. diluting aqueous hydrogen peroxide solution with softened or deionized water to a concentration less than 10% (w/w), preferably less than 6% (w/w);

b. adding alkali metal hydroxide or alkali earth metal hydroxide, or solutions of alkali metal hydroxide or alkali earth metal hydroxide to adjust the pH of the resulting peroxide mixture to between 10 to 13.5;

c. adding a suitable O-acetyl or N-acetyl donor such that the ratio of peroxide to acetyl group in the reaction mixture is at least 1, more preferably 1.5 or greater;

d. mixing the components sufficiently and for a sufficient time for the two phase mixture to change into a single phase solution, indicating a nearly complete reaction;

e. optionally adding an acid source to the reacted mixture to adjust the mixture pH;

f. optionally adding additional peroxide to the reacted mixture to augment the mixture's peroxide component.

In an embodiment, there is provided a method for producing non-equilibrium peroxycarboxcylic acid comprising:

a. diluting aqueous hydrogen peroxide solution with a dilute alkali metal hydroxide or alkali earth metal hydroxide solution to produce a mixture with a hydrogen peroxide concentration less than 10% (w/w), preferably less than 6% (w/w) and a pH between 10 and 13.5;

b. adding a suitable O-acetyl or N-acetyl donor such that the ratio of peroxide to acetyl group in the reaction mixture is at least 1, more preferably 1.5 or greater;

c. suitably mixing the components for sufficient time to allow complete reaction;

d. optionally adding additional dilute peroxide (<35% w/w) to the reacted mixture to augment the mixture's peroxide component;

e. optionally adding acid to the reacted mixture to adjust the mixture pH;

f. further diluting the mixture with either clean (softened or DI) water or process water to point-of-use biocide concentration.

In an embodiment, there is provided a process for producing an antimicrobial solution at the point-of-use comprising:

a. first diluting aqueous hydrogen peroxide solution with softened or DI water to a concentration less than 10% (w/w), preferably less than 6% (w/w);

b. secondly adding alkali metal hydroxide or alkali earth metal hydroxide, or solutions of alkali metal hydroxide or alkali earth metal hydroxide to adjust the pH of the resulting peroxide mixture to between 11.5-13.5;

c. thirdly adding a suitable O-acetyl or N-acetyl donor such that the ratio of peroxide to acetyl group in the reaction mixture is at least 1, more preferably 1.5 or greater;

d. suitably mixing the components for sufficient time to allow complete reaction;

e. optionally adding acid to the reacted mixture to adjust the mixture pH;

f. optionally adding additional peroxide to the reacted mixture to augment the mixture's peroxide component;

g. further diluting the mixture with either clean (softened or DI) water or process water to point-of-use biocide concentration.

In an embodiment, there is provided a process for producing an antimicrobial solution at the point-of-use comprising:

a. first diluting aqueous hydrogen peroxide solution with a dilute alkali metal hydroxide or alkali earth metal hydroxide solution to produce a mixture with a hydrogen peroxide concentration less than 10% (w/w), preferably less than 6% (w/w) and a pH between 11.5-13.5;

b. next adding a suitable O-acetyl or N-acetyl donor such that the ratio of peroxide to acetyl group in the reaction mixture is at least 1, more preferably 1.5 or greater;

c. suitably mixing the components for sufficient time to allow complete reaction;

d. optionally adding additional peroxide to the reacted mixture to augment the mixture's peroxide component;

e. optionally adding acid to the reacted mixture to adjust the mixture pH;

f. further diluting the mixture with either clean (softened or DI) water or process water to point-of-use biocide concentration.

In an embodiment, there is provided a process for continuously producing an antimicrobial solution at the point-of-use comprising:

a. first continuously diluting aqueous hydrogen peroxide solution with softened or DI water to produce a peroxide feed stream with a concentration less than 10% (w/w), preferably less than 6% (w/w)

b. secondly continuously adding alkali metal hydroxide or alkali earth metal hydroxide, or solutions of alkali metal hydroxide or alkali earth metal hydroxide to adjust the pH of the resulting peroxide feed stream to between 11.5-13.5;

c. continuously adding a acetyl donor to a flowing dilute alkaline peroxide feed stream such that the ratio of peroxide to acetyl group is greater than 1:1.

In an embodiment, there is provided a process for continuously producing an antimicrobial solution at the point-of-use comprising:

a. continuously diluting aqueous hydrogen peroxide solution with softened or DI water to produce a peroxide feed stream with a concentration less than 10% (w/w), preferably less than 6% (w/w)

b. continuously adding alkali metal hydroxide or alkali earth metal hydroxide, or solutions of alkali metal hydroxide or alkali earth metal hydroxide to adjust the pH of the resulting peroxide feed stream to between 11.5-13.5;

c. continuously adding a acetyl donor to a high velocity flowing dilute alkaline peroxide feed stream such that the two-phase droplet flow through a reaction mixer maintains a pseudo-excess of peroxide to acetyl group.

In an embodiment, there is provided a process for continuously producing an antimicrobial solution at the point-of-use comprising:

a. continuously diluting aqueous hydrogen peroxide solution with softened or DI water to produce a peroxide feed stream with a concentration less than 10% (w/w), preferably less than 6% (w/w)

b. continuously adding alkali metal hydroxide or alkali earth metal hydroxide, or solutions of alkali metal hydroxide or alkali earth metal hydroxide to adjust the pH of the resulting peroxide feed stream to between 11.5-13.5;

c. continuously adding a acetyl donor to a flowing dilute alkaline peroxide feed stream such that the ratio of peroxide to acetyl group is greater than 1:1;

d. continuously adding acid to the reacted mixture to lower the pH of the product.

In an embodiment, there is provided a process for continuously producing an antimicrobial solution at the point-of-use comprising:

a. continuously diluting aqueous hydrogen peroxide solution with softened or DI water to produce a peroxide feed stream with a concentration less than 10% (w/w), preferably less than 6% (w/w)

b. continuously adding alkali metal hydroxide or alkali earth metal hydroxide, or solutions of alkali metal hydroxide or alkali earth metal hydroxide to adjust the pH of the resulting peroxide feed stream to between 11.5-13.5;

c. continuously adding a acetyl donor to a flowing dilute alkaline peroxide feed stream such that the ratio of peroxide to acetyl group is greater than 1:1;

d. continuously adding aqueous peroxide to the reacted mixture to augment the concentration of peroxide in the resulting biocide mixture.

In an embodiment, there is provided a process for minimizing product decomposition by continuous production of an antimicrobial solution reacting dilute peroxide with an inorganic base solution and an acetyl donor such that the concentration of the peroxide feed is maintained below 10% (w/w), the pH is maintained between 11.5-13.5, and the acetyl donor is maintained at ratio of greater than 1:1 during the process.

In an embodiment, there is provided a process for continuously producing a non-hazardous antimicrobial solution at the point-of-use by reacting dilute peroxide stream with an inorganic base and an acetyl donor such that the concentration of peroxide is maintained below 10% and the concentration of peroxyacid produced is maintained below 5%.

In an embodiment, there is provided a process for the continuous high-yield production of a biocide mixture by reacting a dilute peroxide feed stream with an acetyl donor such that that the pH of the reaction mixture is maintained at the point of maximum difference between the concentration of —OOH and the concentration of —OH.

In an embodiment, there is provided a biocide composition comprising:

a. aqueous hydrogen peroxide (or an aqueous source of hydrogen peroxide)

b. alkali metal or alkali earth metal hydroxide or solutions of alkali metal hydroxide or alkali earth metal hydroxide and

c. O-acetyl or N-acetyl donor, or solutions of O-acetyl or N-acetyl donors

d. water

wherein the aqueous hydrogen peroxide, water, alkali metal hydroxide are mixed prior to addition of the acetyl donor such that the initial concentration of peroxide is between 0.04-10% (w/w) in the mixture, the initial pH of the mixture is between 11.5 and 13.5. Wherein the acetyl donor is then mixed such that the ratio of peroxide to acetyl group is at least 1 and more preferably 1.5.

In an embodiment, there is provided a biocide composition comprising (by weight percentage): 0.04-10% aqueous hydrogen peroxide solution, 0.01 to 10% triacetin, 0.01 to 3% sodium hydroxide and water.

In an embodiment, there is provided a biocide composition comprising (by weight percentage): 0.04-10% aqueous inorganic peroxide solution, 0.01 to 10% acetyl donor, 0.01 to 3% inorganic base and water.

In an embodiment, there is provided a liquid biocide composition comprising:

a. between 0-5% PAA

b. between 0.04-40% peroxide

c. between 0-3% alkali metal hydroxide

d. between 0.01-10% acetic acid

e. between 0-5% glycerol, or other byproduct.

The system controls flow rates and proportions of feedstocks/reactants, performs the required sequence of reaction steps to produce high yield peroxycarboxcylic acid solutions in a continuous manner, and provides optimal reaction time and reactant mixing for continuous and safe on-site production.

In various embodiments, system features include:

a. maintaining described sequence of steps

b. preventing any dangerous mixtures of incompatible feedstocks in the system or in secondary containment

c. maintaining optimal dilution of HP feed stream.

d. maintaining optimal reaction mixture pH by proportional alkali feed stream flow

e. maintaining specified ratio of peroxide to acyl group (peroxide to triacetin stoichiometry)

f. providing optimal reaction time for high yield PAA product

g. providing optimal mixing of heterogeneous reaction mixture

h. providing optimal ‘plug flow’ reaction mixture for enhanced yield

i. providing sufficient day tank (buffer tank) to allow for product delivery during periods of system maintenance

j. optionally providing stream of treated, or clean process water

In various embodiments, dilution includes less than 10% (w/w) aqueous HP, less than 6% (w/w) aqueous HP, less 3.5% (w/w) aqueous HP, between 1% and 5% (w/w) aqueous HP, and between 0.1% and 5% (w/w) aqueous HP.

In various embodiments, ratios include greater than 1-fold excess peroxide to acyl group, greater than 1.5 fold excess peroxide to acyl group, greater than 2.0 fold excess peroxide to acyl group, and greater than 1-fold and less than 2-fold excess peroxide to acyl group.

Acyl donors that may be used with this device include N-acetyl and 0-acetyl donors. O-acetyl donors that may be used include, but are not limited to, monoacetin, diacetin, triacetin, and acetylsalicylic acid.

Plug flow in the mixer provides the conditions for fastest reaction time to produce peroxycarboxcylic acids, which is important for on-demand production. Plug flow conditions will exist in the mixer when the flow rate of the stream and volume of the mixer create conditions that minimize backflow for a given volume of the stream.

The water stream may be municipal water, softened municipal water, or deionized water.

Piping and instrumentation diagrams of several embodiments of a peracetic acid generation system in accordance with the present invention are attached hereto in the Supplemental Materials in Support of the Application section.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. A number of specific groups of variable definitions have been described herein. It is intended that all combinations and subcombinations of the specific groups of variable definitions are individually included in this disclosure. Compounds described herein may exist in one or more isomeric forms, e.g., structural or optical isomers. When a compound is described herein such that a particular isomer, enantiomer or diastereomer of the compound is not specified, for example, in a formula or in a chemical name, that description is intended to include each isomers and enantiomer (e.g., cis/trans isomers, R/S enantiomers) of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Isotopic variants, including those carrying radioisotopes, may also be useful in diagnostic assays and in therapeutics. Methods for making such isotopic variants are known in the art. Specific names of compounds are intended to be exemplary, as it is known that one of ordinary skill in the art can name the same compounds differently.

Molecules disclosed herein may contain one or more ionizable groups, groups from which a proton can be removed (e.g., —COOH) or added (e.g., amines) or which can be quaternized (e.g., amines). All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every formulation or combination of components described or exemplified herein can be used to practice embodiments of the invention, unless otherwise stated. One of ordinary skill in the art will appreciate that starting materials, catalysts, reagents, synthetic methods, purification methods, analytical methods, and assay methods, other than those specifically exemplified can be employed in the practice of embodiments of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of embodiments of the invention claimed. Thus, it should be understood that although embodiments of the present invention has been specifically disclosed by examples, preferred embodiments and optional features, modification and variation of the concepts herein disclosed may be resorted to by those skilled in the art, and that such modifications and variations are considered to be within the scope of this invention as defined by the appended claims.

Whenever a range is given in the specification, for example, a temperature range, a time range, a pH range, a composition or concentration range, or an amount, concentration, or other value or parameter given as a range, preferred range, or a list of upper preferable values and lower preferable values, all intermediate ranges and subranges, as well as all individual values included in the ranges given are intended to be included in the disclosure. This is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of embodiments of the invention be limited to the specific values recited when defining a range. The upper and lower limits of the range may themselves be included in the range. It will be understood that any subranges or individual values in a range or subrange that are included in the description herein can be excluded from the claims herein.

All patents and publications mentioned in the specification are indicative of the levels of skill of those skilled in the art to which embodiments of the invention pertains. Unless otherwise stated, references cited herein are incorporated by reference herein in their entirety to provide the reader with a more complete background and it is intended that this information can be employed herein, if needed, to exclude specific embodiments that are in the prior art. The references are not to be construed as an admission that such references constitute prior art for patentability determination purposes.

What is claimed is:

1. A method for the continuous production of non-equilibrium peracetic acid solutions containing biocidal concentrations of peroxycarboxylic acids, the method comprising:
providing a source of hydrogen peroxide having an initial pH of less than 7.0;
diluting the hydrogen peroxide with water to create a diluted solution having a concentration which is less than 10% weight/volume;
adding an alkali metal hydroxide to the diluted solution to adjust the pH to a pH in a range of approximately 10.0 to approximately 13.5;
reacting the diluted solution with an O-acetyl or N-acetyl donor;
vigorously mixing the solution.

2. The method of claim 1 further including the step of controlling the stoichiometry of the peroxide component with respect to the acetyl donor to bias the reaction in favor of either producing peracetic acid or producing a solution having a specified remaining concentration of peroxide.

3. The method of claim 1 wherein the alkali metal hydroxide is sodium hydroxide.

4. The method of claim 1 wherein the alkali metal hydroxide is potassium hydroxide.

5. The method of claim 1 wherein the O-acetyl donor is triacetin.

6. The method of claim 1 wherein the step of mixing the solution includes producing a turbulent flow having high shear within the solution and having a Reynolds number of 500 or greater.

7. The method of claim 1 including the step of vigorously mixing the solution following the diluting step.

8. The method of claim 7 further including the step of vigorously mixing the solution following the step of adjusting the pH to a range of approximately 10.0 to approximately 13.5.

9. The method of claim 1 including the step of injecting an acid into the solution at a preselected reaction time.

10. The method of claim 9 further including the step of mixing the solution and creating a turbulent flow therein having a Reynolds number of 500 or greater.

11. The method of claim 1 further including the step of adjusting the ratio of peracetic acid to hydrogen peroxide in non-equilibrium solution to provide an excess of hydrogen peroxide therein.

12. the method of claim 11 wherein the excess of hydrogen peroxide is in a range approximately 0.40 lb to approximately 5.0 lb per pound of peracetic acid produced.

13. A system for the continuous production of non-equilibrium peracetic acid solutions containing biocidal concentrations of peroxycarboxylic acids, the system comprising:
a source of a continuous supply of water;
a source of a continuous supply of reactants;
a control system including a flow sensor structured and arranged to control the continuous supply of water and reactants to the system;
a high shear mixing device adapted to controllably mix the water and the reactants in a flow environment having a Reynolds number of 500 or greater;
a continuous tube reactor adapted to receive the water and the reactants from the mixer and to contain the reactants for a residence time within the reactor of sufficient duration to form a single phase solution; and
a discharge system for removing the non-equilibrium peracetic acid solution from the system.

14. The system of claim 13 wherein the continuous tube reactor comprises at least one mixing coil.

15. The system of claim 13 wherein the static mixer is structured and arranged to create a flow of the eater and the reactant mixture having a Reynolds number of 500 or greater.

16. The system of claim 13 wherein the continuous tube reactor includes a first segment and a second segment, each segment having a length and a diameter extending along its length, the diameter of the first segment being larger than the diameter of the second segment.

17. The system of claim 13 wherein the source of continuous water supply and the source of a continuous supply of reactants comprises a plurality of water-powered proportional pumps connected in series.

18. The system of claim 13 further including at least one parallel continuous production system, each of the at least one parallel systems comprising:
a source of a continuous supply of water;
a source of a continuous supply of reactants;
a control system including a flow sensor structured and arranged to control the continuous supply of water and reactants to the system;
a static mixer adapted to controllably mix the water and the reactants;
a continuous tube reactor adapted to receive the water and the reactants from the mixer and to contain the reactants for a residence time within the reactor of sufficient duration to form a single phase solution; and
a discharge system for removing the non-equilibrium peracetic acid solution from the system.

19. The system of claim 13 wherein the source of a continuous supply of reactants comprises a plurality of bladders, each containing a respective one of the reactants.

20. The system of claim 13 further including at least one pH probe adapted to monitor and to create a measurement of the pH of the non-equilibrium peracetic acid solution in the discharge system;

21. The system of claim 20 including a system for adjusting the addition of a quantity of acid into the product.
